(19) United States
(12) Patent Application Publication
(10) Pub. No.: US 2021/0185174 A1
(43) Pub. Date: Jun. 17, 2021

(54) CALL TERMINAL, CALL SYSTEM, CONTROL METHOD OF CALL TERMINAL, AND NON-TRANSITORY RECORDING MEDIUM

(71) Applicant: SHARP KABUSHIKI KAISHA, Sakai City, Osaka (JP)

(72) Inventors: TAKEAKI SUENAGA, Sakai City, Osaka (JP); HISAO HATTORI, Sakai City, Osaka (JP); MAKOTO OTSU, Sakai City, Osaka (JP)

(21) Appl. No.: 17/263,538

(22) PCT Filed: Jul. 17, 2019
(86) PCT No.: PCT/JP2019/028141

§ 371 Date: Jan. 26, 2021

(30) Foreign Application Priority Data
Jul. 27, 2018 (JP) 2018-141663

(51) Int. Cl. H04M 3/56; H04M 3/42

(52) U.S. Cl. CPC H04M 3/56; H04M 3/42348

(57) ABSTRACT

A call terminal includes: a reception unit configured to receive voice signals of one or more call partners; a localization position determination unit configured to determine localization positions corresponding to respective voice signals received in the reception unit in a manner of not overlapping with each other; and a voice output unit configured to output voices corresponding to voice signals in a manner that the voices are localized at the localization positions determined by the localization position determination unit.

### TECHNICAL FIELD

The present invention relates to a call terminal, a call system, and a control method of a call terminal, in which a call is performed with multiple people. The present invention also relates to a call program for causing a computer to operate as the call terminal, and a recording medium recording such a call program.

The present application claims priority to Japanese Patent Application No. 2018-141663 filed in Japan on 27 July, 2018, of which contents are incorporated herein by reference.

### BACKGROUND ART

In recent years, as information terminals as typified by smartphones have become widespread, it is commonplace for each individual to acquire various pieces of information and perform communication via the Internet. As such an information terminal, not only the smartphone, but also a smart television capable of receiving information on the Internet via an interface of the television, a smart speaker capable of receiving such information via voices, and the like have been developed, which are appropriately used depending on their purposes and applications.

One example of the communication means using the information terminal is a call. A call, which is communication performed in a conversational style mainly using voices, is capable of implementing natural communication, and is frequently used in the modern life as well. In other words, the information terminal described above is used as a call terminal as well.

### CITATION LIST

### Patent Literature

PTL 1: JP H11-68977 A

### SUMMARY OF INVENTION

### Technical Problem

However, conventionally, a general call made by a call terminal mainly assumes a one-to-one call. A one-to-many or many-to-many call as used in a teleconference system or the like presupposes a dedicated system. For example, a multi-person call system described in PTL 1 presupposes a dedicated call server apparatus.

A main object of one aspect of the present invention is to provide a call terminal capable of appropriately implementing a call by a large number of people, and techniques pertaining to the call terminal.

### Solution to Problem

A call terminal according to one aspect of the present invention includes: a reception unit configured to receive voice signals of one or more call partners; a localization position determination unit configured to determine localization positions corresponding to respective voice signals received in the reception unit in a manner of not overlapping with each other; and a voice output unit configured to output voices corresponding to voice signals in a manner that the voices are localized at the localization positions determined by the localization position determination unit.

A call system according to one aspect of the present invention is a call system including: a call terminal; and a call server, wherein the call terminal receives voice signals of one or more call partners, the call system comprises a localization position determination unit configured to determine localization positions corresponding to respective voice signals received by the call terminal in a manner of not overlapping with each other, and the call terminal outputs voices corresponding to the received voice signals in a manner that the voices are localized at the localization positions determined by the localization position determination unit.

A control method of a call terminal according to one aspect of the present invention includes: a reception step of receiving voice signals of one or more call partners; a localization position determination step of determining localization positions corresponding to respective voice signals received in the reception step in a manner of not overlapping with each other; and a voice output step of outputting voices corresponding to voice signals in a manner that the voices are localized at the localization positions determined by the localization position determination step.

### Advantageous Effects of Invention

According to one aspect of the present invention, a call by a large number of people can be appropriately implemented by using a call terminal.

### BRIEF DESCRIPTION OF DRAWINGS

FIG. 1 is a block diagram illustrating a principal configuration of a call terminal according to a first embodiment.

FIG. 2 is a diagram illustrating examples of a localizable range according to the first embodiment.

FIG. 3 is a diagram illustrating examples of localization positions of voices according to the first embodiment.

FIG. 4 is a diagram illustrating examples of localization positions of voices according to the first embodiment.

FIG. 5 is a diagram illustrating examples of localization positions of voices according to the first embodiment.

FIG. 6 is a diagram illustrating examples of localization positions of voices according to the first embodiment.

FIG. 7 is a flowchart illustrating an example of a procedure of control processing of the call terminal according to the first embodiment.

FIG. 8 is a block diagram illustrating a principal configuration of a call terminal according to a second embodiment.

FIG. 9 is a diagram illustrating examples of a localizable range according to the second embodiment.

FIG. 10 is a flowchart illustrating an example of a procedure of control processing of the call terminal according to the second embodiment.

FIG. 11 is a block diagram illustrating a principal configuration of a call system according to a third embodiment.

### DESCRIPTION OF EMBODIMENTS

Each embodiment of the present invention will be described below in detail. Note that, unless otherwise specifically noted, the configuration described in these embodiments is not to limit the scope of the present invention only to the configuration.

### First Embodiment

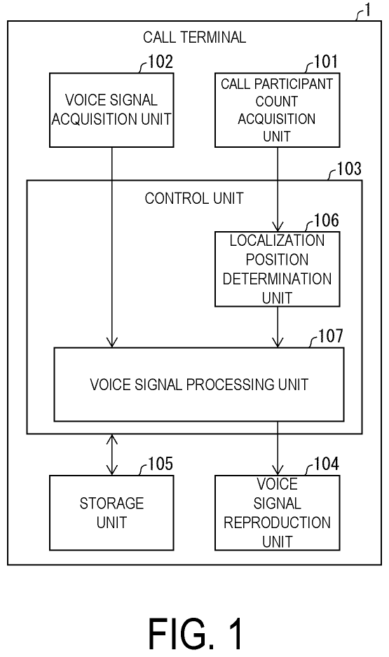

A call terminal 1 and a control method of the call terminal 1 according to a first embodiment will be described below with reference to FIGS. 1 to 7.

### Call Terminal 1

FIG. 1 is a block diagram illustrating a principal configuration of the call terminal 1 according to the first embodiment. As illustrated in FIG. 1, the call terminal 1 includes a call participant count acquisition unit 101, a voice signal acquisition unit (reception unit) 102, a control unit 103, a voice signal reproduction unit (voice output unit) 104, and a storage unit 105.

Note that the call terminal 1 is configured to be capable of implementing a call by a large number of people (at least three people). The call terminal 1 can be appropriately used for a teleconference system, a call system using a VR space, or the like as well. People who participate in a call made by a large number of people are hereinafter referred to as call participants. Among the call participants, a person who operates the call terminal 1 is hereinafter referred to as a user, and people other than the user are hereinafter referred to as call partners.

### Call Participant Count Acquisition Unit 101

The call participant count acquisition unit 101 acquires the number of call partners who are calling the user from the outside of the call terminal 1. In the present embodiment, the number of call partners refers to the number of call participants among the call participants who participate in the call, except for the user himself/herself. For example, in a case where there is a one-to-one call being performed with a certain user, the number of call partners is one, whereas in a case where there is a call being performed with three people being involved, the number of call partners is two. Note that the call participant count acquisition unit 101 may calculate the number of call partners by acquiring the number of call participants who participate in the call and then subtracting 1 from the acquired number.

Note that the call participant count acquisition unit 101 may not be included in the call terminals of all of the call participants. For example, the call terminal 1 of the user may serve as a main terminal, and only the call terminal 1 of the user may include the call participant count acquisition unit 101. In this case, information of the call participant count acquired by the call participant count acquisition unit 101 in the call terminal 1 of the user may be configured to be transmitted to the call terminals of other call participants (call partners). With this configuration, the call participant count can be efficiently acquired while reducing the processing amount of the entire system. Instead of the call terminal of each call participant, a server (not illustrated) may include the call participant count acquisition unit. In this case, information of the call participant count acquired by the call participant count acquisition unit of the server may be configured to be transmitted to the call terminal of each call participant. With this configuration as well, the call participant count can be efficiently acquired while reducing the processing amount of the entire system.

### Voice Signal Acquisition Unit 102

The voice signal acquisition unit 102 acquires a voice signal of each of one or more call partners. Specifically, the voice signal acquisition unit 102 acquires as many voice signals as the number of the call participant count acquired by the call participant count acquisition unit 101 from the outside of the call terminal 1. In the present embodiment, the voice signal is a voice signal corresponding to the voice of the call partner(s) with which the user performs a call, and preferably is a voice signal in a monaural format. The voice signal acquisition unit 102 may be configured to acquire the voice signal that is compressed with some compression method. In this case, the voice signal acquisition unit 102 decodes the acquired voice signal with an appropriate decoding method. The voice signal acquisition unit 102 may be configured to acquire the voice signal in a format other than the monaural format, that is, the voice signal having two or more channels. In this case, the voice signal acquisition unit 102 may be configured to downmix the acquired multi-channel voice signal into a monaural signal.

### Control Unit 103

The control unit 103 controls the call participant count acquisition unit 101, the voice signal acquisition unit 102, the voice signal reproduction unit 104, and the storage unit 105, and inputs and outputs data to and from each of these units. The control unit 103 is, for example, implemented by a central processing unit (CPU) executing a program stored in a prescribed memory. Further, the control unit 103 includes a localization position determination unit 106 and a voice signal processing unit 107.

### Localization Position Determination Unit 106

The localization position determination unit 106 determines the localization positions corresponding to the respective voice signals acquired in the voice signal acquisition unit 102 so that the localization positions do not overlap with each other. The localization positions corresponding to the voice signals refer to the localization positions of the voices corresponding to the respective voice signals in output voices. The localization position determination unit 106 determines each of the localization positions so that the localization positions of the respective voices of one or more call partners do not overlap with each other in output voices output from the call terminal 1. In this manner, the call terminal 1 can output the voices originating from each of the call partners so that the user can easily hear and distinguish the voices. The details of the determination method of the localization position of the voice by the localization position determination unit 106 will be described later.

### Voice Signal Processing Unit 107

The voice signal processing unit 107 configures (generates) voices to be reproduced from the voice signal reproduction unit 104, based on the voice signals of each of the call partners obtained from the voice signal acquisition unit 102 and the localization positions corresponding to the respective voice signals obtained from the localization position determination unit 106.

Here, the voices configured by the voice signal processing unit 107 are voices able to have the user perceive a sense of localization that is based on the localization positions determined by the localization position determination unit 106. The method of implementing the sense of localization varies depending upon the configuration of the voice signal reproduction unit 104. For example, in a case where the voice signal reproduction unit 104 is a pair of headphones or earphones, the voice signal processing unit 107 configures a binaural voice signal that is implemented by using the head-related transfer function (HRTF). In this manner, the voice signal processing unit 107 has the user (listener) perceive the sense of localization. In contrast, in a case where the voice signal reproduction unit 104 is a stereo speaker, the voice signal processing unit 107 may have the user (listener) perceive the sense of localization by configuring a transaural voice signal using the head-related transfer function described above. Further, the voice signal processing unit 107 may configure the voice signal by using sound pressure panning such as vector base amplitude panning (VBAP).

### Voice Signal Reproduction Unit 104

The voice signal reproduction unit (voice output unit) 104 outputs voices so that the voices corresponding to the respective voice signals are localized at the localization positions determined by the localization position determination unit 106. As an example, the voice signal reproduction unit 104 reproduces each voice signal that has been subjected to sound effect processing by the control unit 103 through the speaker, the headphones, the earphones, or the like that is connected to the voice signal reproduction unit 104. In this manner, the voice signal reproduction unit 104 can output the voices and have the user (listener) hear the voices. Further, the voice signal reproduction unit 104 outputs the voices of each of the call partners so that the voices are localized at the localization positions determined by the localization position determination unit 106. In this manner, the voices originating from each of the call partners can be output so that the user can easily hear and distinguish the voices.

### Storage Unit 105

The storage unit 105 includes a secondary storage apparatus for storing prescribed data used by the control unit 103. The storage unit 105 is, for example, implemented as a magnetic disk, an optical disc, or a flash memory. Specifically, the storage unit 105 is implemented as a hard disk drive (HDD), a solid state drive (SSD), a Blu-Ray (trade name) (BD Disc), or the like. The control unit 103 can read data from the storage unit 105 and record data into the storage unit 105 as necessary.

### Determination of Localization Position by Localization Position Determination Unit 106

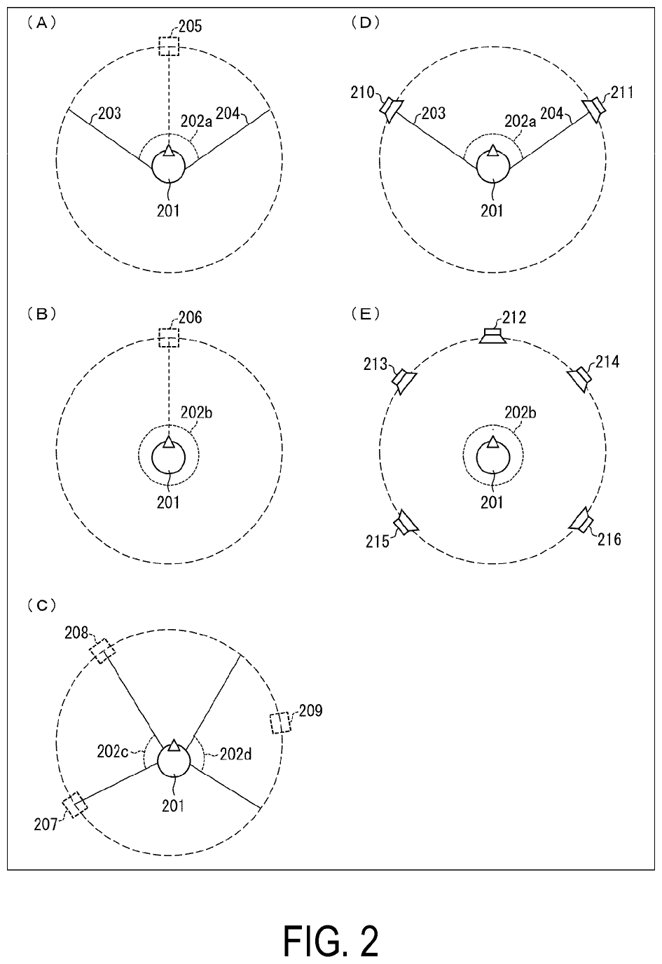

Next, the determination method of the localization position by the localization position determination unit 106 will be described below in detail with reference to FIGS. 2 to 6.

### Configuration of Localizable Range

The localization position determination unit 106 may configure a localizable range, which is a range in which each voice can be localized, before determining the localization positions of the voices corresponding to voice signals. In this manner, the localization position of each voice can be more appropriately determined. Note that the localization position determination unit 106 may determine the localization position of each voice without configuring the localizable range. The configuration method of the localizable range by the localization position determination unit 106 will be described below with reference to FIG. 2. FIG. 2 is a diagram illustrating examples of the localizable range according to the first embodiment.

### Configuration Example 1 of Localizable Range

In one aspect, for example, as illustrated in (A) of FIG. 2, the localization position determination unit 106 may configure a localizable range 202a, which is defined between a localizable range start position 2030 and a localizable range end position 204 within a circle about a user 201 (around the user 201). In this case, the localization position determination unit 106 determines the localization position (for example, the localization position 205) of each voice in the localizable range 202a.

In one aspect, for example, the call terminal 1 may include a range input unit 108 (not illustrated), such as a keyboard or a touch panel, that receives input of the localizable range from the user 201, and the localization position determination unit 106 may configure the range input into the range input unit 108 as the localizable range. For example, the range input unit 108 is configured to receive input of the localizable range start position 203 and the localizable range end position 204, and the localization position determination unit 106 configures the range defined between the localizable range start position 203 and the localizable range end position 204 as the localizable range 202a.

In this manner, in a case where the number of call partners is small, for example, the range to which attention should be paid during a call can be reduced by limiting the localizable range 202a, whereas in a case where the number of call partners is large, for example, the voices originating from each of the call partners can be made to be more easily heard and distinguished by widening the localizable range 202a.

Note that the radius of the circle about the user 201 being used for defining the localizable range is not specifically limited, and may be set to any distance. For example, the localization position determination unit 106 may determine the radius of the circle by receiving the distance from the user 201 to the localization position of the voice via any command input unit 109 (not illustrated), such as a keyboard or a touch panel, from the user 201.

### Configuration Example 2 of Localizable Range

The user 201 may input the localizable range start position 203 and the localizable range end position 204 to be the same. The user 201 may omit the input of the localizable range. In such cases, as illustrated in (B) of FIG. 2, the localization position determination unit 106 may configure the localizable range to be a localizable range 202b, which corresponds to the whole circle about the user 201. In this case, the localization position determination unit 106 determines the localization position (for example, the localization position 206) of each voice in the localizable range 202b.

### Configuration Example 3 of Localizable Range

The above example describes a case in which the localizable range is a continuous range. However, the localizable range need not necessarily be such a continuous range. For example, as illustrated in (C) of FIG. 2, the localization position determination unit 106 may configure a plurality of non-continuous localizable ranges 202c and 202d as the localizable range.

### Configuration Example 4 of Localizable Range

In one aspect, the call terminal 1 may include a detection unit 110 (not illustrated) that detects ambient sound of the call terminal 1, and the localization position determination unit 106 may determine the localization positions corresponding to voice signals so as to avoid the generation source of the sound detected by the detection unit 110.

For example, in a case where the detection unit 110 detects sound such as television sound from the front side of the user 201, as illustrated in (C) of FIG. 2, the localization position determination unit 106 configures the non-continuous localizable ranges 202c and 202d except for the front side of the user 201 as the localizable range, and determines localization positions 207 to 209 of each voice in the localizable ranges 202c and 202d. In this manner, the localization position determination unit 106 can determine the localization positions corresponding to the voice signals so as to avoid the generation source of the sound detected by the detection unit 110.

In this manner, for example, even in a case where sound such as television sound is generated from a certain direction, the voices originating from the call partners can be arranged to be heard from a direction different from the generation source of the sound. In this manner, the user 201 can be made to more easily hear and distinguish the voices originating from each of the call partners. Note that, as long as the configuration of determining the localization position of each voice so as to avoid the generation source of sound is adopted, the configuration is not limited to the configuration of configuring the localizable range so as to avoid the generation source of sound. The localization position determination unit 106 may be configured to determine the localization position of each voice so as to avoid the generation source of sound in a freely configured localizable range.

### Configuration Example 5 of Localizable Range

In one aspect, the localization position determination unit 106 may configure the localizable range, based on the range in which the voice signal reproduction unit 104 can actually localize the output voice. Specifically, the localization position determination unit 106 may configure the localizable range, based on the position of the voice signal reproduction unit 104 or the position of the voice signal reproduction unit 104 and a voice signal configuration method of the voice signal processing unit 107.

For example, as illustrated in (D) of FIG. 2, it is assumed that the voice signal reproduction unit 104 is stereo speakers 210 and 211, and the voice signal configuration method of the voice signal processing unit 107 is VBAP. In this case, the range in which the voice signal reproduction unit 104 can localize the output voice is a range between the stereo speaker 210 and the stereo speaker 211. In this case, the localization position determination unit 106 may determine a line connecting the user 201 and the stereo speaker 210 as the localizable range start position 203, and configure a line connecting the user 201 and the stereo speaker 211 as the localizable range end position 204.

As illustrated in (E) of FIG. 2, in a case where the voice signal reproduction unit 104 is 5.1-ch multi-channel speakers 212 to 214 disposed adjacently to each other on the circle about the user 201, and the voice signal configuration method of the voice signal processing unit 107 is VBAP, the voice signal reproduction unit 104 can localize the output voice at omnidirectional positions as seen from the user 201. In this case, the localization position determination unit 106 may configure, for example, the localizable range 202b illustrated in (B) of FIG. 2 as the localizable range.

### Configuration Example 6 of Localizable Range

In the above example, the localization position determination unit 106 configures the localizable range in advance. However, the present embodiment is not limited to this. In the present embodiment, the localization position determination unit 106 may configure or change (reconfigure) the localizable range during a call.

For example, during a call, the call terminal 1 may receive a change command of the localization position from the user 201 via the command input unit 109, and the localization position determination unit 106 may change the localization positions corresponding to the voice signals, based on the change command. In this manner, for example, during a call, in a case where it is difficult to hear the voices originating from each of the call partners due to a reason such as that the range of the localization position is excessively wide or is excessively narrow, by changing the configuration of the localizable range, the localization positions of the voices originating from each of the call partners can be changed to the positions that allow the voices to be more easily heard and distinguished.

### Configuration Example 7 of Localizable Range

In the above example, the localization position determination unit 106 configures at least a part of the range in the circle about the user 201 as the localizable range. However, the present embodiment is not limited to this. In the present embodiment, the localization position determination unit 106 can determine any range as the localizable range. In one aspect, the localization position determination unit 106 may configure at least a part of the range on a semicircle about the user 201 as the localizable range. In this case, the localization position determination unit 106 can determine the above of the user 201 as the localization position of the voice. Further, in one aspect, the localization position determination unit 106 may configure a range on the circumference of the circle about the user 201 as the localizable range, and determine the localization position of each voice on the circumference. Further, in one aspect, the localizable range may have a shape other than a circle.

### Determination of Localization Position

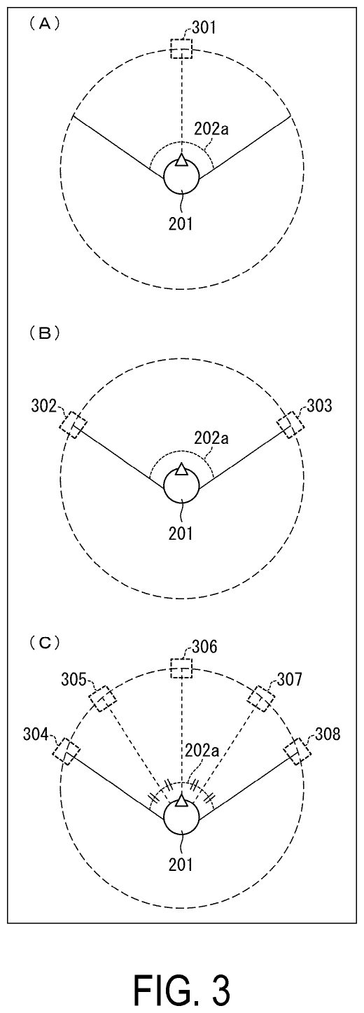

Next, the determination method of the localization position of the output voice originating from the call partner will be described with reference to FIGS. 3 to 6.

### Determination Example 1 of Localization Position

An example of the determination method of the localization position of the voice (output voice originating from each call partner) corresponding to the voice signal of each call partner by the localization position determination unit 106 will be described with reference to FIG. 3. Note that, in the following description, it is assumed that the localization position determination unit 106 configures the localizable range 202a.

In a case where the number of call partners is one, as illustrated in (A) of FIG. 3, the localization position determination unit 106 determines a localization position 301 which is determined in advance in the localizable range 202a as the localization position of the voice originating from the call partner. Note that, although the localization position 301 is a position in front of the user 201, this is not restrictive. The localization position determination unit 106 may determine another position, or the localization position may be determined based on a command of the user 201 via the command input unit 109.

In a case where the number of call partners is two or more, the localization position determination unit 106 determines the localization positions of the voices originating from each of the call partners so that the localization positions of the voices do not overlap with each other. Specifically, the localization position determination unit 106 determines the localization positions of the voices originating from each of the call partners at positions different from each other in the localizable range 202a, and preferably determines the localization positions of the voices originating from each of the call partners so that the directions in which the voices originating from each of the call partners arrive the user 201 do not overlap with each other. For example, as illustrated in (B) of FIG. 3, the localization position determination unit 106 may determine localization positions 302 and 303 of the voices originating from each of the call partners at both the ends of the localizable range 202a.

In one aspect, the localization positions corresponding to each voice signal may be determined so that the intervals between the adjacent localization positions are uniform in the localizable range 202a. For example, as illustrated in (C) of FIG. 3, the localization position determination unit 106 determines the localization positions so that the intervals between two adjacent localization positions are uniform in the localizable range 202a of the voices. Specifically, the localization position determination unit 106 determines the localization positions of the voices originating from five call partners at the positions to equally divide the localizable range 202a of the voices into four parts. In this manner, the voices originating from each of the call partners can be more easily heard and distinguished.

As described above, in a case where the localization position determination unit 106 determines the localization positions of the voices originating from each of the call partners, based on the number of call partners, the voices of each of the call partners can be output so that the user 201 can more easily hear and distinguish the voices, depending on the number of call partners.

### Determination Example 2 of Localization Position

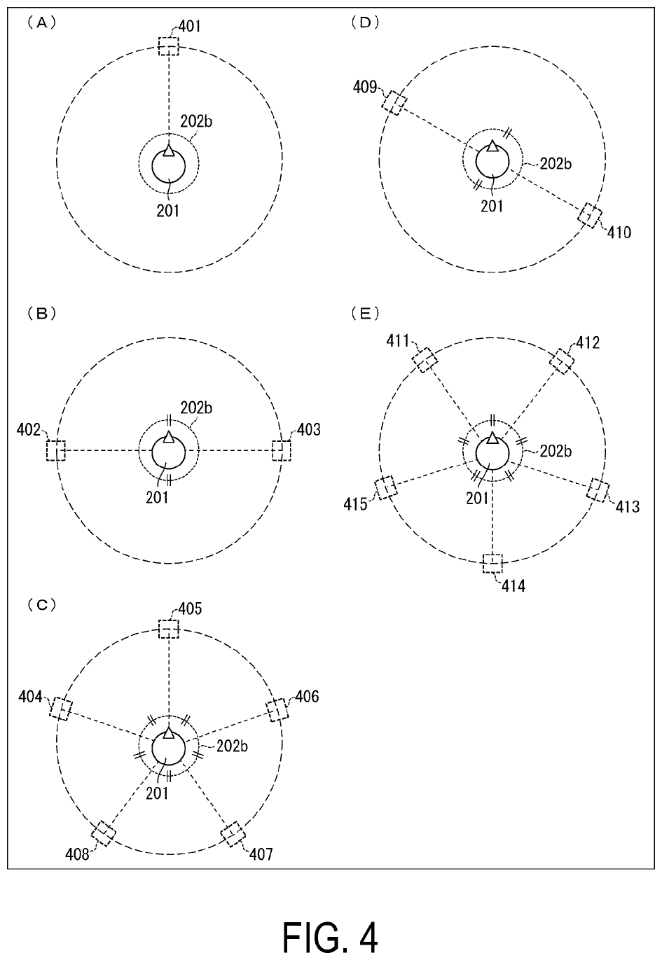

Another example of the determination method of the localization position of the voice (output voice originating from each call partner) corresponding to the voice signal of the call partner by the localization position determination unit 106 will be described with reference to FIG. 4. Note that, in the following description, it is assumed that the localization position determination unit 106 configures the localizable range 202b.

In a case where the number of call partners is one, as illustrated in (A) of FIG. 4, the localization position determination unit 106 determines a localization position 401 which is determined in advance and is a position in front of the user 201 in the localizable range 202b, for example, as the localization position. Note that the position of the localization position 401 is not limited to this.

In a case where the number of call partners is two or more, the localization position determination unit 106 determines the localization positions of the voices originating from each of the call partners so that the localization positions of the voices do not overlap with each other. Specifically, the localization position determination unit 106 determines the localization positions of the voices originating from each of the call partners at positions different from each other in the localizable range 202b, and preferably determines the localization positions of the voices originating from each of the call partners so that the directions in which the voices originating from each of the call partners arrive the user 201 do not overlap with each other.

In one aspect, the localization positions corresponding to each voice signal may be determined so that the intervals between the adjacent localization positions are uniform in the localizable range 202b.

For example, as illustrated in (B) and (C) of FIG. 4, the localization position determination unit 106 determines the localization positions so that the intervals between two adjacent localization positions are uniform in the localizable range 202b of the voices. For example, in a case where the number of call partners is two, as illustrated in (B) of FIG. 4, the localization position determination unit 106 determines the localization positions of the voices originating from the two call partners at the positions to equally divide the localizable range 202b of the voices into two parts. For example, in a case where the number of call partners is five, as illustrated in (C) of FIG. 4, the localization position determination unit 106 determines the localization positions of the voices originating from the five call partners at the positions to equally divide the localizable range 202b of the voices into five parts. In this manner, the voices originating from each of the call partners can be more easily heard and distinguished.

In a case where equally dividing the localizable range 202b into parts, the localization position determination unit 106 can equally divide the localizable range 202b in any manner of equal division. For example, in a case where the call participant count is two and the localization position determination unit 106 determines the positions to equally divide the localizable range 202b into two parts as the localization positions of the voices originating from each of the call partners, the localization position determination unit 106 may determine localization positions 409 and 410 illustrated in (D) of FIG. 4 instead of localization positions 402 and 403 illustrated in (B) of FIG. 4. In a case where the call participant count is five and the localization position determination unit 106 determines the positions to equally divide the localizable range 202b of the voices into five parts as the localization positions of the voices originating from each of the call partners, the localization position determination unit 106 may determine localization positions 411 to 415 illustrated in (E) of FIG. 4 instead of localization positions 404 to 408 illustrated in (C) of FIG. 4.

### Determination Example 3 of Localization Position

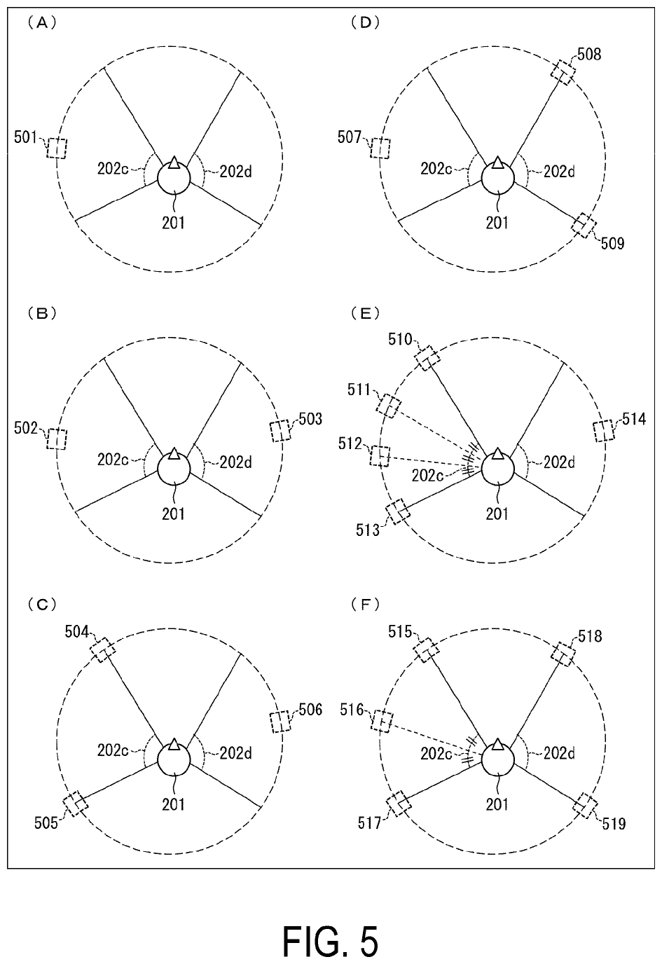

Another example of the determination method of the localization position of the voice (output voice originating from each call partner) corresponding to the voice signal of the call partner by the localization position determination unit 106 will be described with reference to FIG. 5. Note that, in the following description, it is assumed that the localization position determination unit 106 configures the localizable ranges 202c and 202d.

In a case where the number of call partners is one, the localization position determination unit 106 determines the localization position which is determined in advance in any of the localizable ranges 202c and 202d as the localization position of the voice originating from the call partner. For example, as illustrated in (A) of FIG. 5, the localization position determination unit 106 may determine a localization position 501 which is determined in advance in the localizable range 202c as the localization position of the voice originating from the call partner.

In a case where the number of call partners is two or more, the localization position determination unit 106 determines the localization positions of the voices originating from each of the call partners so that the localization positions of the voices do not overlap with each other. In this case, the localization position determination unit 106 determines the localization positions so that the localization positions are distributed in both the localizable range 202c and the localizable range 202d.

For example, in a case where the number of call partners is two, as illustrated in (B) of FIG. 5, the localization position determination unit 106 determines one localization position in each of the localizable ranges 202c and 202d (the localization position 502 in the localizable range 202c and the localization position 503 in the localizable range 202d).

Further, for example, in a case where the number of call partners is three, as illustrated in (C) of FIG. 5, the localization position determination unit 106 may determine two localization positions (504 and 505) in the localizable range 202c and determine one localization position (506) in the localizable range 202d. As illustrated in (D) of FIG. 5, the localization position determination unit 106 may determine one localization position (507) in the localizable range 202c and determine two localization positions (508 and 509) in the localizable range 202d.

Further, for example, in a case where the number of call partners is five, the localization position determination unit 106 determines the localization positions so that the intervals between the adjacent localization positions of the voices of the call participants are uniform in each of the localizable ranges 202c and 202d. In this case, for example, as illustrated in (E) of FIG. 5, the localization position determination unit 106 may determine four localization positions 510 to 513 in the localizable range 202c and determine one localization position 514 in the localizable range 202d. As illustrated in (F) of FIG. 5, the localization position determination unit 106 may determine three localization positions 515 to 517 in the localizable range 202c and determine two localization positions 518 and 519 in the localizable range 202d.

In this case, as illustrated in (E) and (F) of FIG. 5, it is preferable that the localization position determination unit 106 determine each of the localization positions so that the intervals between the adjacent localization positions of the voices of the call participants are uniform in at least one of the localizable ranges 202c and 202d of the voices.

In this manner, by determining the localization positions so that the intervals between the adjacent localization positions of the voices of the call participants are uniform in at least one of the localizable ranges 202d and 202d in a case where the call participant count is three or more, the voices of each of the call participants can be easily localized at the positions where the user 201 can easily hear and distinguish the voices.

### Determination Example 4 of Localization Position

The localization position determination unit 106 may change the localization position of the voice originating from the call partner during a call. In this manner, even in a case where it is difficult for the user 201 to hear and distinguish the voices localized at the localization positions of the voices determined in advance, the user 201 can cause the localization position determination unit 106 to change the localization positions of the voices originating from each of the call partners afterwards by inputting a change command via the command input unit 109, for example. As a result, the localization positions of the voices originating from each of the call partners can be determined at appropriate positions where the user 201 can more easily hear and distinguish the voices.

### Determination Example 5 of Localization Position

In a case where the change command via the command input unit 109 is a rotation command of the localization positions, the localization position determination unit 106 may rotate the localization positions of the voices originating from each of the call partners about the user 201 (listener of each voice), based on the rotation command.

For example, it is assumed that the number of call partners is two, and the localization position determination unit 106 determines the localizable range to be the localizable range 202b. In this case, based on the command of the user 201, the localization position determination unit 106 may perform rotation from the localization positions 402 and 403 illustrated in (B) of FIG. 4 to the localization positions 409 and 410 illustrated in (D) of FIG. 4 about the user 201 (listener of each voice). Then, the localization position determination unit 106 may determine the localization positions of the voices originating from each of the call partners at the localization positions 409 and 410 after the rotation.

Further, for example, it is assumed that the number of call partners is five, and the localization position determination unit 106 determines the localizable range to be the localizable range 202b. In this case, based on the command of the user 201, the localization position determination unit 106 may rotate the localization positions 404 to 408 of the voices originating from each of the call partners illustrated in (C) of FIG. 5 to the localization positions 411 to 415 illustrated in (E) of FIG. 5 about the user 201 (listener of each voice). Then, the localization position determination unit 106 may determine the localization positions of the voices originating from each of the call partners at the localization positions 411 to 415 after the rotation.

In this manner, for example, even in a case where it is difficult to hear and distinguish the voices originating from each of the call partners heard from the localization positions of the voices determined in advance during a call with the call partners, the localization positions of the voices originating from the call partners can be changed to the positions where the user 201 can more easily hear and distinguish the voices originating from each of the call participants.

### Determination Example 6 of Localization Position

In the above example, in a case where the number of call partners is a prescribed number or more, the localization position determination unit 106 determines each of the localization positions in the localizable range so that the intervals between the adjacent localization positions are uniform. Note that the localization position determination unit 106 need not determine each of the localization positions so that the intervals between the adjacent localization positions are uniform.

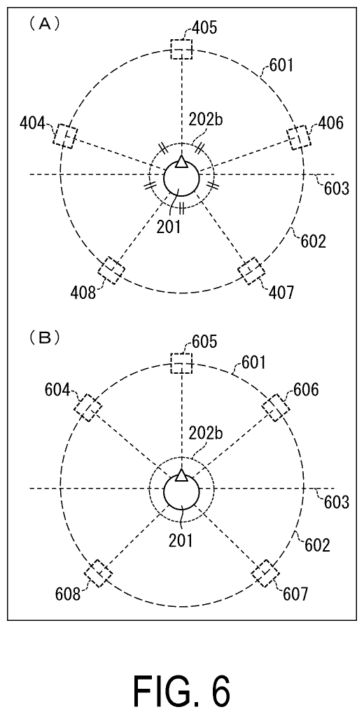

With reference to FIG. 6, an example of the determination method of the localization position of the voice of the call participant by the localization position determination unit 106 will be described below. FIG. 6 is a diagram illustrating an example of the localization position of the voice according to the first embodiment.

For example, in a case where the number of call partners is five, the localization position determination unit 106 may equally divide the localizable range 202b into five parts as illustrated in (A) of FIG. 6, or may not equally divide the localizable range 202b into five parts as illustrated in (B) of FIG. 6. In particular, in a case where the localizable range 202b is divided into a front region 601 and a rear region 602 by a boundary line 603, the user 201 may perceive the voices from the rear less clearly than the voices from the front. In this case, as illustrated in (B) of FIG. 6, the localization position determination unit 106 can output each voice to the user more appropriately by determining the interval between localization positions 607 and 608 in the rear region 602 to be wider than each of the intervals between adjacent ones of localization positions 604 to 606 in the front region 601.

The localization position determination unit 106 may determine each of the localization positions so that the localization positions of the voices originating from each of the call partners are separated away from each other at least by a prescribed angle or more as seen from the user 201. Although the prescribed angle is not particularly limited, the prescribed angle may be set to 1 degree, 5 degrees, 10 degrees, 15 degrees, 20 degrees, 25 degrees, 30 degrees, or the like, as appropriate. In this manner as well, the localization positions can be determined in a range where the user 201 can easily hear the voices of the call partners.

### Control Processing of Call Terminal 1

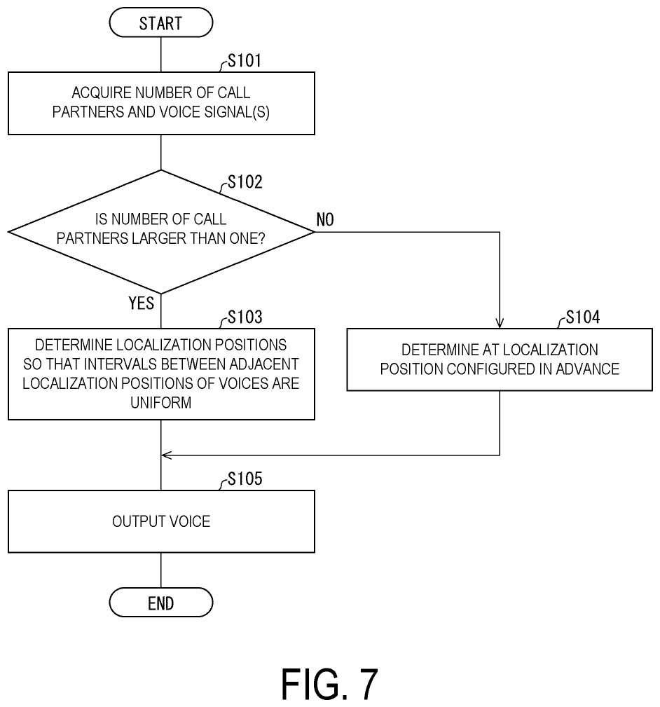

Next, with reference to FIG. 7, the procedure of the control processing of the call terminal 1 (control method of the call terminal) according to the present embodiment will be described. FIG. 7 is a flowchart illustrating an example of the procedure of the control processing of the call terminal 1 according to the first embodiment.

In Step S101, the call participant count acquisition unit 101 acquires the number of call partners from the outside of the call terminal 1. Further, the voice signal acquisition unit 102 acquires (receives) the voice signals of each of one or more call partners (reception step, voice signal acquisition step). Subsequently, the processing proceeds to Step S102.

In Step S102, the localization position determination unit 106 determines whether the number of call partners acquired by the call participant count acquisition unit 101 is larger than one. In a case where the number of call partners is larger than one (YES in Step S102), the processing proceeds to Step S103. In a case where the number of call partners is one (NO in Step S102), the processing proceeds to Step S104.

In Step S103, the localization position determination unit 106 determines the localization positions corresponding to the respective voice signals acquired in the voice signal acquisition step so as not to overlap with each other (localization position determination step). In this case, preferably, the localization position determination unit 106 determines the localization positions so that the intervals between the adjacent localization positions of the voices of the call participants are uniform. Subsequently, the processing proceeds to Step S105.

In Step S104, the localization position determination unit 106 determines the localization positions of output voices originating from the call partners at the positions determined in advance (localization position determination step). Subsequently, the processing proceeds to Step S105.

In Step S105, the voice signal processing unit 107 generates the output voices so that the voices corresponding to the voice signals of each of the call partners are localized at the localization positions determined in the localization position determination step, and causes the voice signal reproduction unit 104 to output the generated output voices (voice output step).

Through the processing described above, a call by a large number of people can be appropriately implemented by using the call terminal 1.

### Second Embodiment

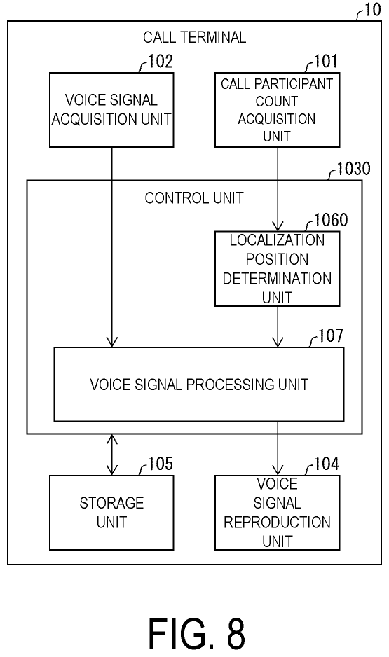

The call terminal 10 according to the second embodiment will be described below with reference to FIGS. 8 to 10. Note that, for the sake of convenience of description, members having the same functions as the members described in the first embodiment are denoted by the same reference signs, and the description thereof will be omitted.

### Call Terminal 10

FIG. 8 is a block diagram illustrating a principal configuration of the call terminal 10 according to the second embodiment.

As illustrated in FIG. 8, the call terminal 10 includes a control unit 1030 instead of the control unit 103 of the call terminal 1 according to the first embodiment. Except for this configuration, the call terminal 10 has the same configuration as the call terminal 1 according to the first embodiment.

### Control Unit 1030

As illustrated in FIG. 8, the control unit 1030 includes a localization position determination unit 1060 instead of the localization position determination unit 106 according to the first embodiment. Except for this configuration, the control unit 1030 has the same configuration as the control unit 103 according to the first embodiment.

### Localization Position Determination Unit 1060

The localization position determination unit 1060 determines the localization positions corresponding to the voice signals of each of the call partners, based on the number of call partners obtained from the call participant count acquisition unit 101.

In one aspect, the localization position determination unit 1060 determines the localizable range such that the localizable range is increased as the number of call partners is increased. For example, localizable ranges determined in advance may be stored in the storage unit 105 depending on the number of call partners, and the localization position determination unit 1060 may determine a localizable range by reading a localizable range according to the number of call partners from the storage unit 105.

By determining the localizable range such that the localizable range is increased as the number of call partners is increased, in a case where the number of call partners is small, the localizable range is reduced, and thus the range to which attention should be paid during a call can be reduced to the minimum necessary, whereas in a case where the number of call partners is large, the localizable range is increased, and thus each of the localization positions can be disposed so that a large number of voices can be heard and distinguished.

Then, the localization position determination unit 1060 determines the localization positions corresponding to the respective voice signals so that the intervals between the adjacent localization positions are uniform and the intervals are the largest in the determined localizable range. In this manner, the localization position determination unit 1060 can determine appropriate localization positions according to the number of call partners obtained from the call participant count acquisition unit 101.

Note that the present embodiment is not limited to this. The localization position determination unit 1060 may determine the localization positions so that the intervals between the localization positions are smaller as the number of call partners is larger. In this manner as well, the localization position determination unit 1060 can determine appropriate localization positions according to the number of call partners obtained from the call participant count acquisition unit 101.

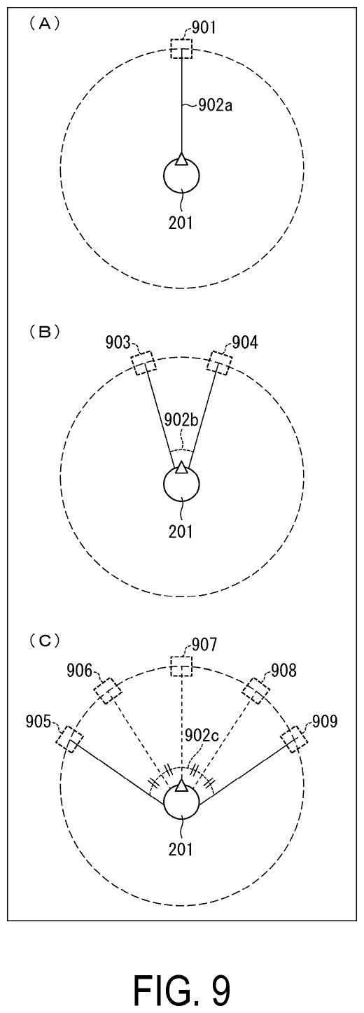

An example of the determination method of the localizable range and the localization position by the localization position determination unit 1060 will be described below with reference to FIG. 9. FIG. 9 is a diagram illustrating examples of the localizable range according to the second embodiment.

In a case where the number of call partners is one, as illustrated in (A) of FIG. 9, the localization position determination unit 1060 determines the localizable range to be a localizable range 902a being a straight line in front of the user 201. Further, the localization position determination unit 1060 determines the localization position of the voice originating from the call partner at a localization position 901 that is uniquely determined based on the localizable range 902a.

In a case where the number of call partners is two, as illustrated in (B) of FIG. 9, the localization position determination unit 1060 determines the localizable range to be a localizable range 902b corresponding to a case in which the call participant count is two. Further, the localization position determination unit 1060 determines localization positions 903 and 904 of the voices originating from each of the call partners so that the intervals between the adjacent localization positions are uniform in the localizable range 902b.

In a case where the call participant count is five, as illustrated in (C) of FIG. 9, the localization position determination unit 1060 determines the localizable range to be a localizable range 902c corresponding to a case in which the call participant count is five. Further, the localization position determination unit 1060 determines each of the localization positions of the voices originating from each of the call partners at localization positions 905 to 909 at which the localizable range 902c is equally divided into four parts so that the intervals between the adjacent localization positions are uniform in the localizable range 902c.

Note that, in the present embodiment as well, the localization position determination unit 1060 may change the localizable range and the localization position during a call. In this manner, for example, even in a case where it is difficult to hear and distinguish the voices originating from each of the call partners heard from the localization positions in the localizable range determined in advance during a call with the call partners, the localization positions of the voices originating from the call partners can be changed to positions where the user 201 can more easily hear and distinguish the voices.

### Control Processing of Call Terminal 10

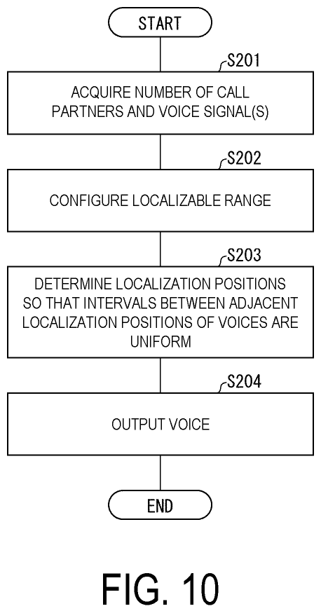

Next, with reference to FIG. 10, the procedure of the control processing of the call terminal 10 (control method of the call terminal) according to the present embodiment will be described. FIG. 10 is a flowchart illustrating an example of the procedure of the control processing of the call terminal 10 according to the second embodiment.

In Step S201, the call participant count acquisition unit 101 acquires the number of call partners from the outside of the call terminal 1. Further, the voice signal acquisition unit 102 acquires (receives) the voice signals of each of one or more call partners (reception step, voice signal acquisition step).

In Step S202, the localization position determination unit 1060 determines the localizable range of the voices, based on the call participant count acquired from the call participant count acquisition unit 101.

In Step S203, the localization position determination unit 1060 determines the localization positions corresponding to the respective voice signals acquired in the voice signal acquisition step so as not to overlap with each other. Further, the localization position determination unit 1060 determines each of the localization positions so that the intervals between the adjacent localization positions in the determined localizable range are uniform (localization position determination step).

In Step S204, the voice signal reproduction unit 104 outputs the voices corresponding to the respective voice signals so that the voices are localized at the localization positions determined in the localization position determination step of Step S203, and ends the processing (voice output step).

### Third Embodiment

The function of the call terminal 1 according to the first embodiment may be implemented by a call system 100 according to a third embodiment.

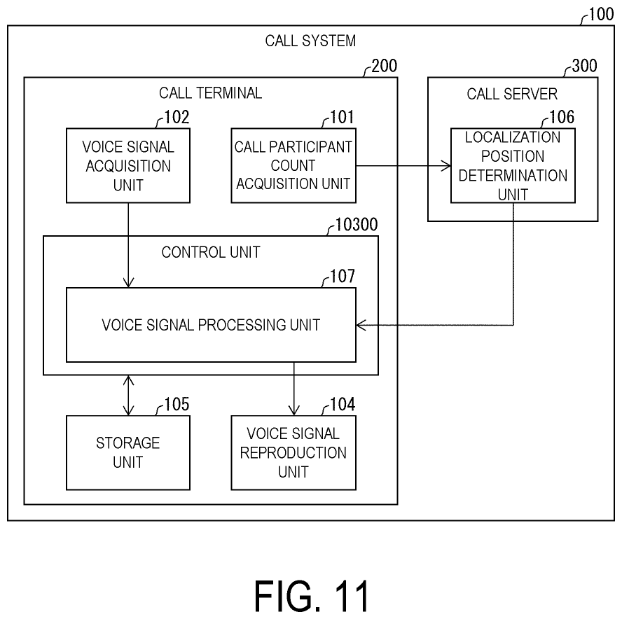

The call system 100 according to the third embodiment will be described below with reference to FIG. 11. Note that, for the sake of convenience of description, members having the same functions as the members described in the embodiments described above are denoted by the same reference signs, and the description thereof will be omitted.

### Call System 100

FIG. 1 is a block diagram illustrating a principal configuration of the call system 100 according to the third embodiment. The call system 100 includes a call terminal 200 and a call server 300. The call server 300 includes the localization position determination unit 106.

In this manner, in the call system 100, the call terminal 200 includes a control unit 10300 not including the localization position determination unit 106 instead of the control unit 103 including the localization position determination unit 106 in the call terminal 1 according to the first embodiment, and the call system 100 further includes the call server 300 including the localization position determination unit 106.

In the call system 100, the call terminal 200 receives the voice signals of each of one or more call partners, and the call system 100 includes the localization position determination unit 106 that determines the localization positions corresponding to the respective voice signals received by the call terminal 200 so as not to overlap with each other, and the call terminal 200 outputs the voices corresponding to the received voice signals so that the voices are localized at the localization positions determined by the localization position determination unit 106.

More specifically, as illustrated in FIG. 11, in the call system 100, the call participant count acquisition unit 101 of the call terminal 200 acquires the number of call partners, and the voice signal acquisition unit 102 acquires the voice signals of each of the call partners. The localization position determination unit 106 of the call server 300 determines the localization positions corresponding to the respective voice signals acquired in the voice signal acquisition unit 102 of the call terminal 200 so as not to overlap with each other. The voice signal processing unit 107 of the call terminal 200 configures (generates) the voices to be reproduced from the voice signal reproduction unit 104, based on the voice signals of each of the call partners obtained from the voice signal acquisition unit 102 of the call terminal 200 and the localization positions corresponding to the respective voice signals obtained from the localization position determination unit 106 of the call server 300. The voice signal reproduction unit 104 of the call terminal 200 outputs the voices corresponding to the respective voice signals so that the voices are localized at the localization positions determined by the localization position determination unit 106 of the call server 300.

In this manner, the call system 100 functions in a manner similar to the call terminal 1 according to the first embodiment as a whole. According to the call system 100, with the call server 300 performing the processing of the localization position determination unit 106, the processing amount of the call terminal 200 can be reduced.

Note that the above example describes a case in which, in the call system 100, the call server 300 includes the localization position determination unit 106 instead of the call terminal 200. However, the present embodiment is not limited to this. In the present embodiment, it is only necessary that the call terminal 200 include at least the voice signal reproduction unit 104, and the call server 300 may include other members instead of the call terminal 200. For example, the call server 300 may include the storage unit 105, the localization position determination unit 106, and the control unit 10300, that is, the storage unit 105 and the control unit 103 of FIG. 1, instead of the call terminal 200, and the call server 300 may further include the call participant count acquisition unit 101 and the voice signal acquisition unit 102 in addition to the control unit 103 and the storage unit 105 instead of the call terminal 200. In this case as well, the call system 100 can function in a manner similar to the call terminal 1 according to the first embodiment as a whole while reducing the processing amount of the call terminal 200.

### Implementation Example by Software

Control blocks of the call terminal 1 or 10 (in particular, the localization position determination unit 106 or 1060 and the voice signal reproduction unit 104) may be implemented by logic circuits (hardware) formed in integrated circuits (IC chips) and the like, or may be implemented by software.

In the latter case, the call terminal 1 or 10 is provided with a computer that executes commands of a call program, which is software for implementing each function. The stated computer includes at least one processor (control apparatus), for example, and includes at least one computer-readable recording medium having stored the call program therein. In the computer, the processor reads out the call program from the recording medium and executes the call program, thereby accomplishing the object of the present embodiment. For example, a Central Processing Unit (CPU) may be used as the processor. As the recording medium, a “non-transitory tangible medium” such as a tape, a disk, a card, a semiconductor memory, and a programmable logic circuit may be used in addition to a Read Only Memory (ROM). A Random Access Memory (RAM) on which the call program is loaded, or the like may be further provided. The call program may be supplied to the computer via any transmission medium (communication network, broadcast wave, or the like) capable of transmitting the call program. Note that an aspect of the present invention may be implemented in a form of data signal embedded in a carrier wave, which is embodied by electronic transmission of the call program.

1. A call terminal comprising:
a reception unit configured to receive voice signals of one or more call partners;
a range input unit configured to receive input of a localizable range;
a localization position determination unit configured to determine localization positions corresponding to respective voice signals in the localizable range received in the reception unit in a manner of not overlapping with each other; and
a voice output unit configured to output voices corresponding to voice signals in a manner that the voices are localized at the localization positions determined by the localization position determination unit.

2. The call terminal according to claim 1,
wherein the localization position determination unit determines the localization positions corresponding to the voice signals according to the number of the one or more call partners.

3. The call terminal according to claim 1,
wherein the localization position determination unit determines the localization positions corresponding to the voice signals in a manner that intervals between adjacent ones of the localization positions are uniform.

4. The call terminal according to claim 1, further comprising
a command input unit configured to receive a change command of the localization positions,
wherein the localization position determination unit changes the localization positions corresponding to the voice signals, based on the change command.

5. The call terminal according to claim 4,
wherein the change command is a rotation command of the localization positions, and
the localization position determination unit rotates the localization positions corresponding to the voice signals about a listener of the voices, based on the rotation command.

6. The call terminal according to claim 1, further comprising
a detection unit configured to detect sound around the call terminal,
wherein the localization position determination unit determines the localization positions corresponding to the voice signals to avoid a generation source of the sound detected by the detection unit.

7. (canceled)

8. A call system comprising:
a call terminal; and
a call server,
wherein the call terminal receives voice signals of one or more call partners,
the call server comprises
a range input unit configured to receive input of a localizable range,
a localization position determination unit configured to determine localization positions corresponding to respective voice signals in the localizable range received by the call terminal in a manner of not overlapping with each other, and
the call terminal outputs voices corresponding to the received voice signals in a manner that the voices are localized at the localization positions determined by the localization position determination unit.

9. A control method of a call terminal, the control method comprising:
a reception step of receiving voice signals of one or more call partners;
a range input step of receiving input of a localizable range,
a localization position determination step of determining localization positions corresponding to respective voice signals in the localizable range received in the reception step in a manner of not overlapping with each other; and
a voice output step of outputting voices corresponding to voice signals in a manner that the voices are localized at the localization positions determined by the localization position determination step.

10. A non-transitory computer-readable recording medium recording a call program for causing a computer to function as the call terminal according to claim 1, wherein
the call program is a call program for causing the computer to function as the localization position determination unit.

11. (canceled)
